(19) United States
(12) Patent Application Publication
(10) Pub. No.: US 2005/0151831 A1
(43) Pub. Date: Jul. 14, 2005

(54) Light emitting device

(75) Inventor: Nobuo Katsuma, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/033,807

(22) Filed: Jan. 13, 2005

(30) Foreign Application Priority Data
Jan. 13, 2004 (JP) 2004-005948

(51) Int. Cl. B41J 2/45

(52) U.S. Cl. 347/238; 347/171

(57) ABSTRACT

An optical fixing unit has a light emitting element array on which plural light emitting elements are arranged in a matrix-like form along a scanning direction and a sub scanning direction. The light emitting element array consists of a first block which has an illuminance correcting section for correcting illumination distribution in the scanning direction, and a second block which has not the illuminance correcting section. In the first block, a current control section is connected to each light emitting element line in the sub scanning direction, for changing integral illuminance of each line by controling current flowing to the line. An LED control circuit checks illumination distribution of the whole array, and adjusts the illuminance of the first block such that the illumination distribution of the whole array is corrected to be even. The illuminance correction is performed such that a duty ratio of drive-pulse signals entering the current control section is changed.

### BACKGROUND OF THE INVENTION

1. Field of the Invention

The present invention relates to a light emitting device including a light emitting element array on which plural light emitting elements are arranged in a matrix, and emitting light toward a photosensitive material relatively moving against the light emitting element array.

2. Description Related to the Prior Art

As disclosed in U.S. Pat. No. 5,986,682, an optical fixing unit for a thermal printer is known as a light emitting device to emit light toward a photosensitive material. The optical fixing unit emits fixing light toward a thermosensitive recording paper, on which an image has already been recorded thermally by a thermal head, to optically fix thermosensitive coloring layers. In U.S. Pat. No. 5,986,682, the optical fixing unit has a light emitting element array on which plural light emitting elements are arranged in lengthwise and breadthwise along a feeding direction of the thermosensitive recording paper (a sub scanning direction) and along a width direction of the recording paper (a scanning direction), such as a matrix. The optical fixing unit is disposed on a conveyer passage, and emits the fixing light toward a whole recording surface of the thermosensitive recording paper on passage.

When using this type of the light emitting element array, if the illuminance varies in the respective lines along sub scanning direction, the illumination distribution becomes uneven in the scanning direction, which causes unevenness of fixation on the thermosensitive recording paper. In view of this, the applicant has proposed an illuminance correcting method for the light emitting element array, in the U.S. patent application publication 2003/0142195. In this illuminance correcting method, the illumination distribution in the scanning direction is corrected by adjusting illuminance of respective lines along the sub scanning direction. For example, current control sections for adjusting value of current flowing to respective lines are provided in the respective lines to adjust the illuminance of respective lines along the sub scanning direction in accordance with measured illumination distribution in the scanning direction. Accordingly, the uneven illuminance in the scanning direction can be corrected.

However, the number or the light emission amount of the light emitting element is increased to increase the illuminance, there rises a need to use large transistors and resistors for controlling increased driving current. Accordingly, electric power loss (energy loss by increase of electric energy consumed in the current control section) and an increased parts cost will be caused. When the number of light emitting elements becomes larger, the electric power loss and the increased parts cost will be unignorable. Therefore, measures for minimizing these problems are needed.

### SUMMARY OF THE INVENTION

An object of the present invention is to provide a light emitting device whose illuminance is even in a scanning direction, without causing an electric power loss and a parts cost increase.

In order to achieve the above object, a light emitting device of the present invention has a light emitting element array on which plural light emitting elements are arranged in a matrix-like form along a first direction and a second direction. The light emitting element array includes at least a first block and a second block which are separated in the second direction. The first block has an illuminance correcting section for correcting illumination distribution thereof in the first direction such that the illumination distribution of the light emitting element array becomes approximately even in the first direction.

It is preferable that the light emitting elements in the first block are connected in series along the second scanning direction to form a light emitting element line, and the illuminance correcting section has a current control section which is connected in series to the light emitting element line to control current flowing to the light emitting element line.

According to the present invention, because the illumination distribution of the light emitting element array comprising the first and the second blocks becomes even in the first direction by the illuminance correcting section for correcting illumination distribution of the first block in the first direction, the number of the light emitting elements to be controlled can be reduced. Therefore, components of the illuminance correcting section can be downsized. Because of that, the light emitting device, with even illuminance in the scanning direction can be provided, without causing the electric power loss and the parts cost increase.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is a schematic illustration showing a structure of a color thermal printer;

FIG. 2 is an explanatory illustration showing an LED-arrangement in a light emitting element array;

FIG. 3 is an explanatory illustration showing a circuitry of the light emitting element array;

FIG. 4 is a flowchart showing a sequence for correcting an illuminance;

FIG. 5 is an explanatory illustration showing an example of a current control section which can measure temperature of the light emitting element; and

FIG. 6 is an explanatory illustration showing an example of the current control section which consists only of a variable resistor.

### PREFERRED EMBODIMENTS OF THE INVENTION

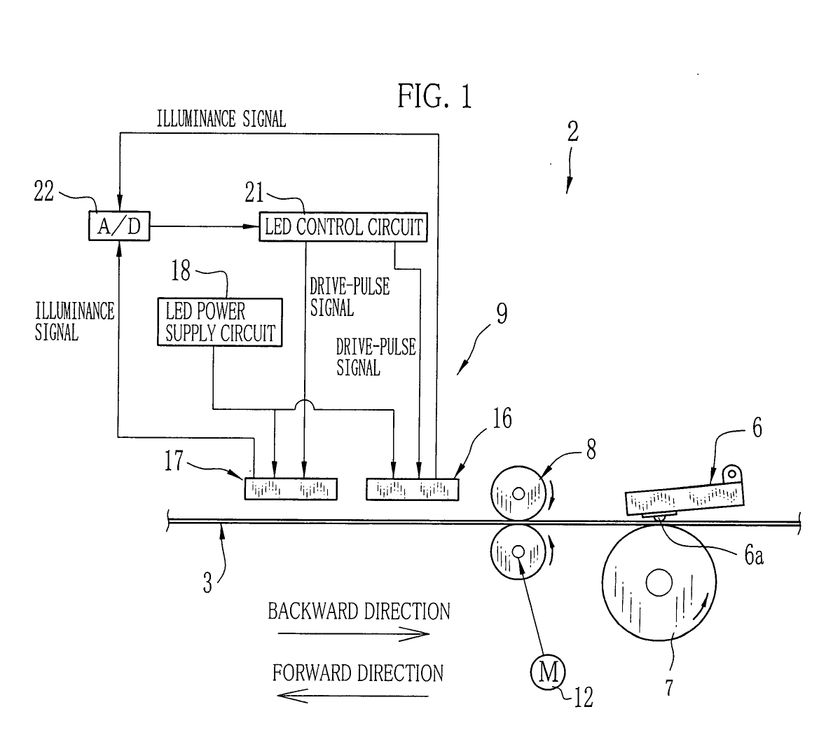

A color thermal printer 2 shown in FIG. 1 reciprocates a color thermosensitive recording paper 3 in a forward direction and a backward direction to thermally record a full-color image and optically fix the color thermosensitive recording paper 3 on which the image is thermally recorded. The color thermal printer 2 comprises a thermal head 6 to heat and color each of thermosensitive coloring layers of the recording paper, a platen roller 7 confronting the thermal head 6 to support the recording paper 3, a conveyor roller pair 8 to convey the recording paper 3, and an optical fixing unit 9.

The color thermosensitive recording paper 3 comprises a cyan thermosensitive coloring layer, a magenta thermosensitive coloring layer, and a yellow thermosensitive coloring layer, which are stacked in order on a support as well known. The yellow thermosensitive coloring layer is the uppermost layer and has the highest thermal sensitivity so as to color in yellow with small thermal energy. The cyan thermosensitive coloring layer is the lowermost layer and has the lowest thermal sensitivity so as to color in cyan with great thermal energy. The yellow thermosensitive coloring layer, which is the first thermosensitive coloring layer, loses an ability to color when near ultraviolet rays of 420 nm is applied thereto. The magenta thermosensitive coloring layer, which is the second thermosensitive coloring layer to color in magenta with the intermediate thermal energy between the yellow and cyan thermosensitive coloring layers do, loses an ability to color when ultraviolet rays of 365 nm is applied thereto. The color thrmosensitive recording paper 3 may have a four-layer structure that includes a black thermosensitive coloring layer, for example.

The conveyor roller pair 8 nips to convey the recording paper 3 in a sub scanning direction. During this conveyance, the color thermosensitive recording paper 3 passes the thermal head 6 and the optical fixing unit 9 for a printing process. After the printing process, the recording paper 3 is cut into a predetermined size by a cutter, which is not shown, and is discharged to the outside of the color thermal printer 2. The conveyance roller pair is driven by a drive motor 12.

As well known, the thermal head 6 includes a heating element array 6a in which a large number of heating elements align in a scanning direction. Each of the heating elements generates thermal energy in accordance with pixel density so as to thermally record an image of each color of yellow, magenta and cyan on the respective thermosensitive coloring layers.

The optical fixing unit 9 comprises a light emitting element array 16 for yellow and a light emitting element array 17 for magenta. The arrays 16 and 17 are disposed at a downstream side of the thermal head 6 in the forward direction, and luminescent faces thereof confront a recording surface of the color thermosensitive recording paper 3. The light emitting element array for yellow 16 is a light source for fixing the yellow thermosensitive coloring layer by emitting the near ultra-violet rays whose luminescent peak is 420 nm. The light emitting element array 17 for magenta is a light source for fixing the magenta thermosensitive coloring layer by emitting the ultra-violet rays whose luminescent peak is 365 nm. Each of the arrays 16, 17 is longer that than the color thermosensitive recording paper 3 in the scanning direction.

An LED power supply circuit 18 supplies driving power for the arrays 16, 17. An LED control circuit 21 as light-amount control means corrects illuminance of the arrays 16, 17 so as to uniform illumination distribution in the scanning direction. As stated below, light receiving sensors as illuminance measuring means for detecting the illuminance of the light emitting elements are provided in the arrays 16, 17. An illuminance signal from the light receiving sensor is inputted in the LED control circuit 21 through an A/D converter 22. The LED control circuit 21 corrects the illumination distribution of the arrays 16, 17 in the scanning direction based on the illuminance signal.

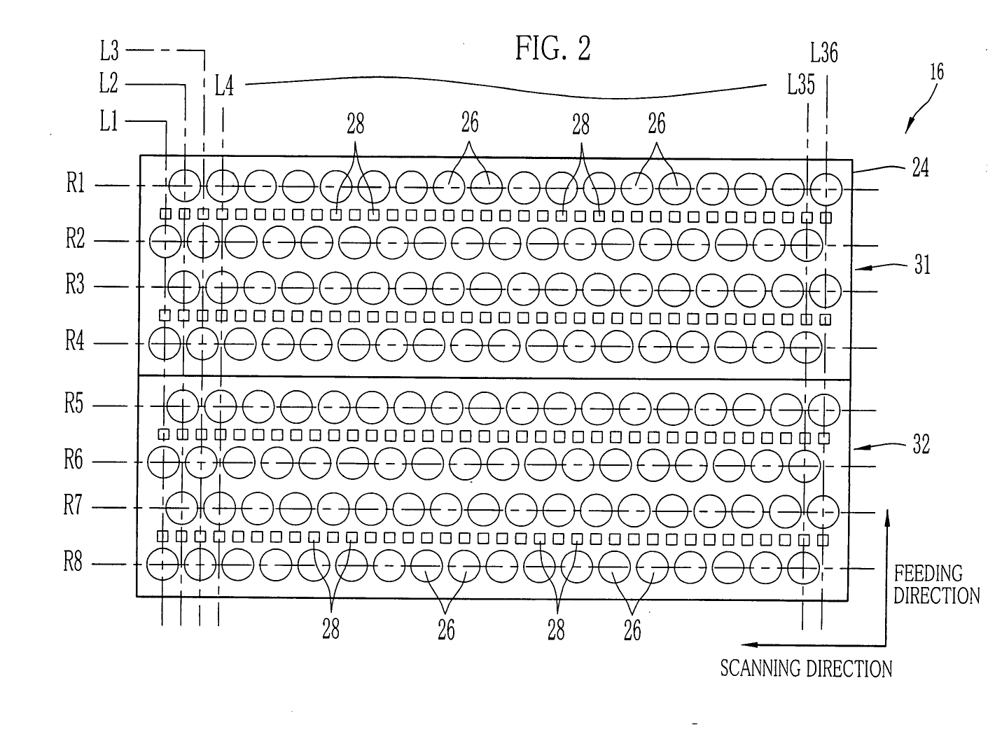

As shown in FIG. 2, in the light emitting element array 16, plural light emitting elements 26 are arranged on a substrate 24 in a matrix-like form which has eight lines (R1-R8) along the scanning direction and thirty-six lines (L1-L36) along the sub scanning direction. As the light emitting element 26, for example, an light-emitting diode (LED) is used.

The illuminance of each light emitting element 26 is high at a central portion thereof and is low at a peripheral portion thereof. In addition, there is a gap between the adjacent light emitting elements 26. Therefore, each line becomes uneven in illuminance along the scanning direction. In view of this, the two adjacent lines are shifted with each other in the scanning direction by half of an arrangement pitch of the light emitting elements 26 so as to arrange the light emitting elements 26 is zigzags. According to this arrangement, the uneven illuminance in the scanning direction is diminished because a low illminance portion in one line is compensated by a high illuminance portion in the other line.

However, if there are some defective light emitting elements caused by bad lighting, bad wiring and so forth, illumance around the defective elements seriously decrease. In addition, the uneven illuminance in the scanning direction is also caused by variation in temperature and deterioration of the light emitting element with the passage of time. In view of this, the light emitting element array 16 is able to control its illuminance based on measured illumination distribution in the scanning direction.

Plural illuminance sensors 28 are arranged on the substrate 24 along the line of the light emitting elements 26 in the scanning direction. The illuminance sensors 28 form one line per every two lines of the light emitting elements 26 such as, for example, one line between R1 and R2, and another line between R3 and R4. As the illuminance sensor 28, for example a photo sensor, which outputs illuminance signal having a level according to an amount of received light, is used. The illuminance signal of analog is converted into digital signal by the A/D converter 22, and is outputted to the LED control circuit 21. The LED control circuit 21 checks integral illumination distribution in the scanning direction by calculating integral illuminance of the respective lines L1-L36 of the light emitting elements 26, on the basis of the inputted illuminance signals. And the LED control circuit 21 adjusts the illuminance of the light emitting elements 26 based on the integral illumination distribution in the scanning direction. Accordingly, the uneven illuminance caused by the defective light emitting elements is corrected.

The light emitting element array 16 consists of a first and a second blocks 31, 32 in which each four line among the eight lines R1-R8 of the light emitting elements 26 is assigned. The first block 31 has an illuminance correcting section for correcting the illumination distribution in the scanning direction by adjusting the illuminance of each line L1-L36. The second block 32 has not the illuminance correcting section. The illuminance correcting section in the first block 31 adjusts the illuminance of each line of the first block 31 so that the uneven illuminance in the scanning direction in the whole array 16 including the second block 32 is corrected.

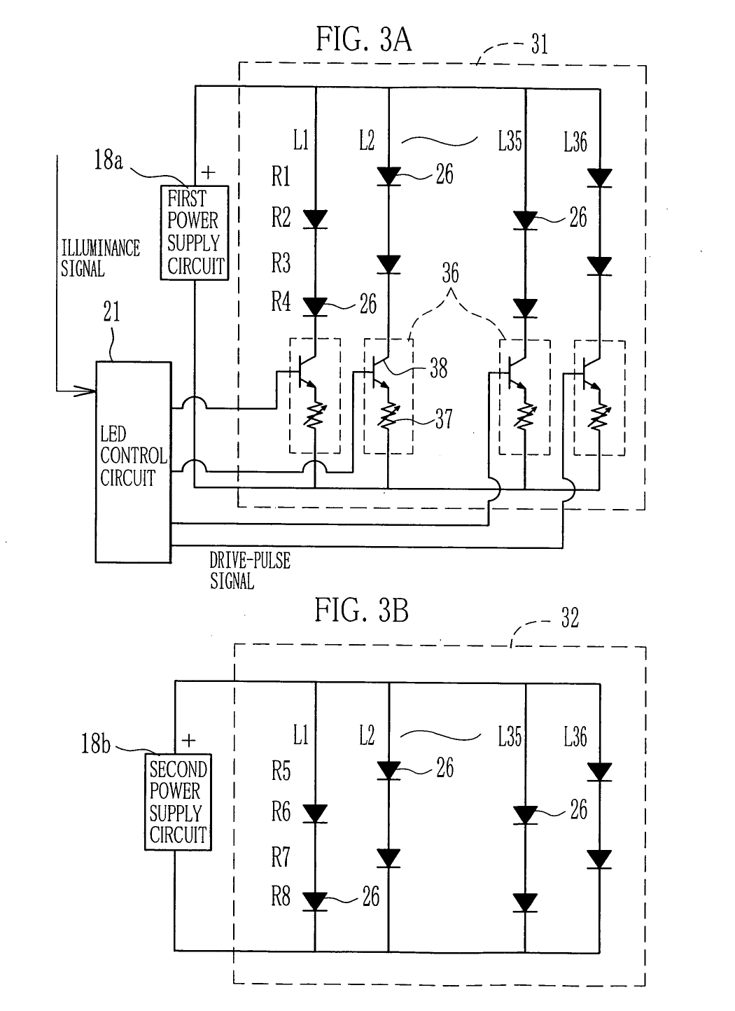

As shown in FIG. 3, the each block 31, 32 is constantly turned on by the electric power supplied from the first and second power supply circuits 18a, 18b of their own. The light emitting elements 26 in the respective blocks 31, 32 are connected in series on every line L1-L36. In the second block 32 shown in FIG. 3B, the illuminance correcting section is not provided. Accordingly, the light emitting elements 26 in the second block 32 are turned on by the continuously flowing current during the second power source 18b applies voltage to it. The second block 32 cannot control illuminance, therefore integral illuminance of the respective lines L1-L36 are varied in the second block 32, if a defective element caused as stated above is there.

In contrast, the first block 31 shown in FIG. 3A has a current control section 36 as the illuminance correcting section on each line L1-L36. The current control sections 36 are connected in series to the light emitting elements 26 in respective lines L1-L36. The current control section 36 is a constant current source which constantly applies current without being influenced by other circuit elements, and consists of for example a variable resistor 37 and a transistor 38. The variable resistor 37 changes value of current flowing to each line L1-L36. In manufacturing the first block 31, resistance of each variable resistor 37 is adjusted so as to uniform the illumination distribution in the scanning direction of the first block 31. Therefore, the uneven illuminance in manufacturing is corrected.

The transistor 38 is a switching member which turns on and off the current flowing to the light emitting elements 26 in each line L1-L36. Although the uneven illuminance of the first block 31 is corrected in manufacturing, however the uneven illuminance is occurred if the defective element is caused as stated above subsequently. The LED control circuit 21 inputs drive-pulse signal into a substrate of each of the transistor 38. While a signal level of the drive-pulse is high, the transistor 38 is turned on so that the light emitting elements 26 in each line emit light. When the signal level of the drive-pulse is low, the light emitting elements 26 are turned off. The LED control circuit 21 adjusts the integral illuminance of each line L1-L36 by changing a duty ratio (a ratio of pulse duration to pulse train cycle) based on the observed value of the integral illuminance of each line L1-L36 in the sub scanning direction on the whole array including the second block 32.

As described above, the one light emitting element array is consisted of the first block 31 having the current control section 36 and the second block 32 not having the current control section 36. Therefore, the number of the light emitting elements 26 to be controlled is reduced in comparison with the conventional light emitting element array in which all of the light emitting elements are controlled. The value of the current flowing through the current control section 36 becomes small because of the reduced number of the light emitting elements 26 to be controlled. Accordingly, the circuit elements such as transistor, resistor and so on can be downsized, and the cost for these elements can be reduced. In addition, electric power loss can be small and energy efficiency can be better by downsizing the circuit elements in the current control section 36.

The foregoing description concerns the light emitting element array 16 for yellow. The light emitting element array 17 for magenta has a similar structure. Therefore a description concering the light emitting element array 17 for magenta is abbreviated.

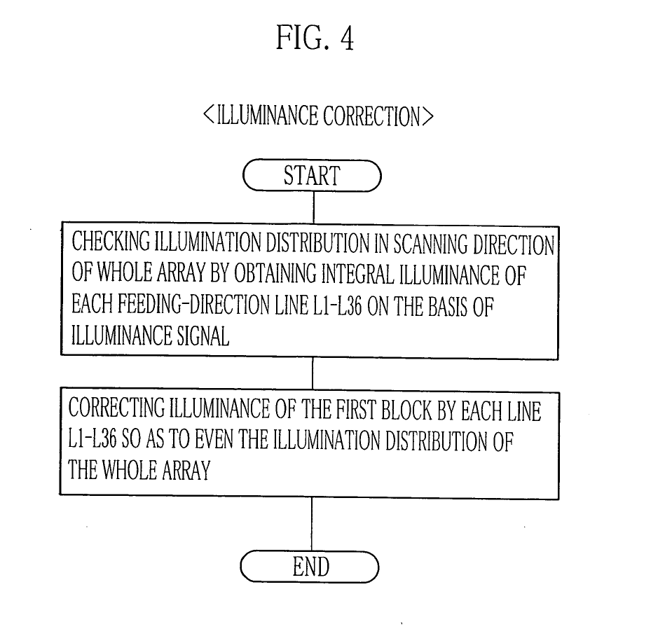

An operation of the above-described structure is explained below, referring to a flowchart shown in FIG. 4. As the color thermosensitive recording paper 3 is fed, the thermal head 6 starts the thermal recording of yellow images. When the thermal recording starts, the light emitting element array 16 for yellow is turned on. The recorded portion of the color thermosensitive recording paper 3 is fed to the light emitting element array 16 for yellow, to be optically fixed by yellow fixing light. While fixing, as shown in FIG. 4, the LED control circuit 21 checks the illumination distribution in the scanning direction of the whole array by calculating integral illuminance of respective lines L1-L36 in the sub scanning direction, on the basis of the illuminance signals from the illuminance sensors 28. Then the LED control circuit 21 controls the duty ratio of the drive-pulse signal for the first block 31 to correct the illuminance in each line L1-L36, such that the illumination distribution of the whole array is uniformed.

After the fixing of the yellow image is finished, the color thermosensitive recording paper 3 is fed in the backward direction, then the thermal head 6 starts the thermal recording of magenta images with the thermosensitive recording paper 3 fed in the forward direction. When the thermal recording starts, the light emitting element array 17 for magenta is turned on. The recorded portion of the color thermosensitive recording paper 3 is fed to the light emitting element array 17 for magenta, to be optically fixed. The LED control circuit 21 corrects the illuminance of the light emitting element array 17 for magenta according to the same process as the magenta light emitting element array 16 for yellow. Accordingly, unevenness of fixation in the scanning direction does not occur. When the fixing of magenta images is finished, cyan images are recorded and then the printing is finished.

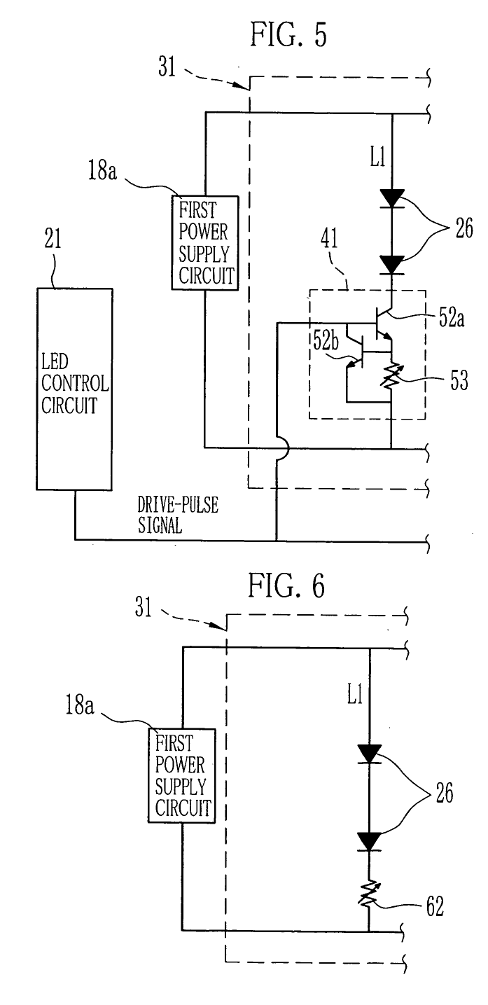

In the above embodiment, the current control section is consisted of one transistor and one variable resistor. However, the circuitry of the current control section is not limited to this embodiment. For example, a current control section 41 shown in FIG. 5 is consisted of two transistors 52a, 52b and a variable resistor 53. The circuitry enables to estimate the temperature of the light emitting element. The acceptable maximum current of the light emitting element changes in accordance with temperature. The higher the temperature is, the smaller the maximum current is. If the current beyond the acceptable value flows in the light emitting element, the life thereof is shortened. Thus, the current flowing in the light emitting element is preferably controlled, in accordance with the temperature of the light emitting element, not to beyond the acceptable maximum current value.

A voltage of a terminal to which the drive-pulse signal is inputted, is the sum of substrate-emitter voltages Vbe of respective transistors 52a and 52b. The LED control circuit 21 measures the temperature of the substrate from the voltage of the terminal, and estimates the temperature of the light emitting element from the measured temperature of the substrate. The LED control circuit 21 adjusts the duty ratio of the drive-pulse based on the estimated temperature of the light emitting element such that the current flowing in the light emitting element is below the maximum current value. Accordingly, the light emitting element is prevented from deteriorating.

As another example, a current control section shown in FIG. 6 is consisted only of a variable resistor 62. In this circuit, resistance of each variable resistor 62 cannot be adjusted during the fixing, but be adjusted only in the manufacturing. However, electric power loss is even smaller and energy efficiency is better in comparison with the above embodiment because of the simplified circuitry.

In the above embodiment, plural light emitting elements are arranged in a matrix-like form which has eight lines along the scanning direction and thirty-six lines along the sub scanning direction. However, the arrangement of the light emitting elements can be changed arbitrary. For example, although each line along sub scanning direction in each block is consisted of four light emitting elements in the above embodiment, there should just be at least one number of light emitting elements for the each line of the each block. In addition, although the current control sections are provided in every line along the sub scanning direction in the above embodiment, for example the current control sections may be provided in every other line. This example is inferior in accuracy of the correction of illuminance, however, it presents the electric power loss and the parts cost increase.

In the above embodiment, the settled optical fixing unit performs the optical fixation during conveyance of the thermosensitive recording paper in the sub scanning direction. However, the optical fixation may be performed such that the optical fixing unit moves on the settled thermosensitive recording paper.

In the above embodiment, the light emitting device of the present invention is applied to the optical fixing unit for the thermal printer. However, the present invention is not limited to the optical fixing unit, and may be applied to other types of the light emitting device such as an illumination device for forming a pattern on a print substrate. The wavelength of the light emitted from the light emitting elements is selected in accordance with the use of the light emitting device.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A light emitting device having luminescent area lengthened in a first direction, and emitting light toward a photosensitive material relatively moving in a second direction which is approximately perpendicular to said first direction, comprising:
a light emitting element array, on which plural light emitting elements are arranged in a matrix form along said first direction and said second direction, including at least a first block and a second block which are separated in said second direction; and
an illuminance correcting section for correcting illumination distribution of said first block in said first direction such that said illumination distribution of said light emitting element array becomes approximately even in said first direction.

2. A light emitting device according to claim 1, wherein said light emitting elements in said first block are connected in series in said second direction to form a light emitting element line, and said illuminance correcting section having a current control section which is connected in series to said light emitting element line and controls current flowing to said light emitting element line.

3. A light emitting device according to claim 2, further comprising:
illuminance measuring means for measuring illuminance of said light emitting elements to output illuminance signals representing said measured illuminance; and
light-amount control means for calculating integral illumination distribution of said light emitting element array in said first direction by integrating said illuminance of each of said light emitting element line along said second direction, on the basis of said illuminance signals, to control said illuminance of said light emitting elements in said first block based on said obtained integral illumination distribution.

4. A light emitting device according to claim 3, wherein said illuminance measuring means comprising:
an illuminance sensor which outputs said illuminance signal of analog having level according to an amount of received light; and
an A/D converter for converting said illuminance signal of analog into digital data.

5. A light emitting device according to claim 4, wherein said light emitting elements in said first block is driven by drive-pulse signals, and said light-amount control means controls said illuminance of said light emitting elements by changing a duty ratio of said drive-pulse signals.

6. A light emitting device according to claim 5, wherein said current control section has a variable resistor for changing value of said current, and a transistor for turning on and off said current according to said drive-pulse signal.

7. A light emitting device according to claim 1, wherein said first direction is a scanning direction, said second direction is a sub scanning direction, said photosensitive material is a thermosensitive recording material already recorded thermally, and said light emitting device performs optical fixation by emitting ultraviolet rays onto said thermosensitive recording material.

8. A light emitting device according to claim 1, wherein said light emitting element is an LED.

9. A light emitting device according to claim 4, wherein said illuminance sensor is a photo sensor.
